(19) United States
(12) Patent Application Publication
(10) Pub. No.: US 2001/0004260 A1
(43) Pub. Date: Jun. 21, 2001

(54) Method, system, and graphic user interface for file system navigation

(75) Inventors: Mathias Bauer, Hamburg (DE); Stefan Taxhet, Hamburg (DE); Lutz Hoger, Hamburg (DE); Hans-Peter Burow, Hamburg (DE)

Correspondence Address: Forrest Gunnison, Gunnison, McKay & Hodgson, L.L.P., 1900 Garden Road, Suite 220, Monterey, CA, 93940, US

(73) Assignee: Sun Microsystems, Inc

(21) Appl. No.: 09/738,456

(22) Filed: Dec. 13, 2000

(30) Foreign Application Priority Data
Dec. 14, 1999 (EP) 99124953.3

(51) Int. Cl. G06F 17/00

(52) U.S. Cl. 345/418

(57) ABSTRACT

A graphic user interface for entering a new file directory on a computer uses a single file navigation dialogue window that displays a user selectable list of predetermined default directories, user-defined directories, and previously used directories. The user uses a single action to navigate among the directories listed in the single file navigation window.

### FIELD OF THE INVENTION

The present invention relates to the file navigation in a computing environment, and more particularly to a method of entering a new directory in the computing environment.

### DESCRIPTION OF THE RELATED ART

Navigation inside a complex file system of a computer system has been an important element of operating system and application software development since the introduction of the computer. The possibility of changing directories and work documents easily and quickly is a requirement for a software user. This is particularly true in a computing environment including a large number of different types of documents like business correspondence, graphics and so forth.

With computers employing a graphical user interface, a so called “file open” dialogue window has come into use which allows the user to move upwards and downwards along a path of a hierarchical directory tree that represents the storage locations of the information on a storage device of the computer. An exemplary hierarchical directory tree 100 is shown in FIG. 1. In this example, the computer system has two hard disk drives, called C and D (of which only the file structure of the former is shown in detail in FIG. 1) that are accessible from the desktop of the computer system.

A large number of directories and subdirectories are arranged hierarchically in the form of a tree on drive C. On the lowest level of directory tree 100, document “Fax XYZ” is located in subdirectory “Fax letters” on drive C and diagram “turnover by regions” is located in subdirectory “Diagrams” on drive D.

If the user working on document “Fax XYZ”, for example, wished to change to another document, i.e., diagram “turnover by regions”, the user had to “click up” directory tree 100 until the user reached the root node of drive C. After the user reached the root node, the user selected directories on drive D until the user reached diagram “turnover by regions,” which the user subsequently entered by a mouse click or the like.

FIG. 2 is an illustration of a prior art graphic user interface that the user used to “click up” directory tree 100. In this embodiment, the user either placed a cursor on File 200 in Tool Bar 1 and clicked a mouse, which generated a pull-down menu on which the user selected “Open,” or alternatively, the user clicked on folder icon 201 in Tool Bar 2. Both of these selections caused open window 220 to be created within window 210.

Open window 220 listed the path 222 of directory “Fax letters” that contained document “Fax XYZ” in which the user was working. Window 225 within window 220 listed any other documents or subdirectories within directory “Fax letters”.

Window 220 also included a plurality of icons 226 to 230. Icons 226 and 227 changed the presentation of the information in window 225. Icon 229 was used to create a new directory within directory “fax letters,” and icon 230 was used to go directly to a default directory that typically was defined by the user. Window 220 typically included other features that are not needed to demonstrate the prior art method of file system navigation and so are not illustrated in FIG. 2.

When the user clicked on icon 228, the display in window 225 moved up to the next higher node in hierarchical tree 100, which in this example is “Business Correspondence” and two directories “Fax Letters” and “Email”, would be displayed in window 225. Thus, as described above, the user repeatedly clicked on icon 228 to move up to root node C and then selected and clicked on directories in window 225 to reach diagram “Turnover by region.” Thus, the user transitions from node to node of tree 100 until the desired node is reached where each node represents a storage location of the corresponding directory or document. Consequently, there is a predefined relationship, as represented by tree 100 between the directories that the user is able to traverse using a single action, e.g., a mouse click.

This way of changing from one working document to another was complicated and time consuming and furthermore required at least some implicit knowledge about where to find a desired document. A similar procedure was necessary if the user wished to save the document in a particular different directory.

Another possibility to enter a desired particular document was to type in the name of the document directly and let the computer operating system search for the document within the file system of the computer system. Typing in the file name, however, was awkward in the case of long file names. Moreover, the user needed to know the exact spelling of the document name.

Another possibility was to have special lists of documents like a history list showing the last used four or five documents or a favorites list, which was accessible, for example, by a separate “start” key. None of these solutions provided an intuitive easy to understand method for quickly and easily navigating through hierarchical tree 100 to a desired location.

### SUMMARY OF THE INVENTION

A method and graphic user interface in one embodiment of the present invention improve file navigation inside a computing environment and enable the user to easily change from one directory to another desired directory. In one embodiment, the method of entering a new file directory on a device includes:

displaying a file navigation icon;

displaying a file navigation dialogue window in response to a selection of the file navigation icon, wherein the file navigation dialogue window comprises a plurality of sections, and further wherein each section includes a different directory category, and each section includes at least one directory in the category; and

displaying contents of a directory in response to selection of the directory in the file navigation window.

The plurality of sections includes a first section comprising a list of predefined default directories; a second section comprising at least one user selected directory; and a third section comprising a last used directory. The predefined default directories contain, for example, a document templates directory. The last used directory contains the latest used directories of the present computer or network session. In one embodiment, the list of user-defined directories includes a shared user directory accessible to a plurality of users.

In another embodiment, the method of entering a new file directory on a device includes:

displaying a file open window including a file navigation icon wherein contents of a first directory are displayed in the file open window;

displaying a file navigation dialogue window in response to a selection of the file navigation icon, wherein the file navigation dialogue window comprises a plurality of sections, and further wherein each section includes a different directory category, and each section includes at least one directory in the category; and

displaying contents of a second directory, selected in the file navigation window, in the file open window where there is no predefined hierarchical relationship between the first directory and the second directory.

A computer graphic user interface, according to this invention includes a file open window. The file open window includes a directory content window and a file navigation icon. Upon a first action on the file navigation icon, contents of a directory are displayed in the directory content window. Upon a second action on the file navigation icon, a file navigation dialogue window is displayed.

In one embodiment, the file navigation dialogue window includes a first section comprising a list of predefined default directories; a second section comprising at least one user selected directory; and a third section comprising a last used directory.

The file navigation dialogue window, according to the present invention, allows the user to easily and quickly find a desired directory in the computer system. The user may select from defined default directories including, for example, the most frequently used document templates, user-defined directories in which the user may include the documents he or she prefers, and a history list of latest used documents.

The file navigation window preferably is context-independent, that is the style and content of the window are displayed in the same manner irrespective of the document or environment the user is currently working on.

The file navigation, in this embodiment of the present invention, inside a computing environment, which may be a single personal computer or workstation or a computer network, is greatly improved and facilitated for the user. In one single dialogue window, the user can select among a large number of directories including predetermined default directories, user-defined directories and previously used directories irrespective of the relative physical storage locations of the various directories. The directories and documents available through this dialogue window, thus, can be adapted by the user according to the needs of the user. In practice, most of the documents a user wishes to enter can be retrieved easily using only one dialogue window.

### BRIEF DESCRIPTION OF THE DRAWINGS

FIG. 1 illustrates an example of a prior art hierarchical directory tree in a computer system.

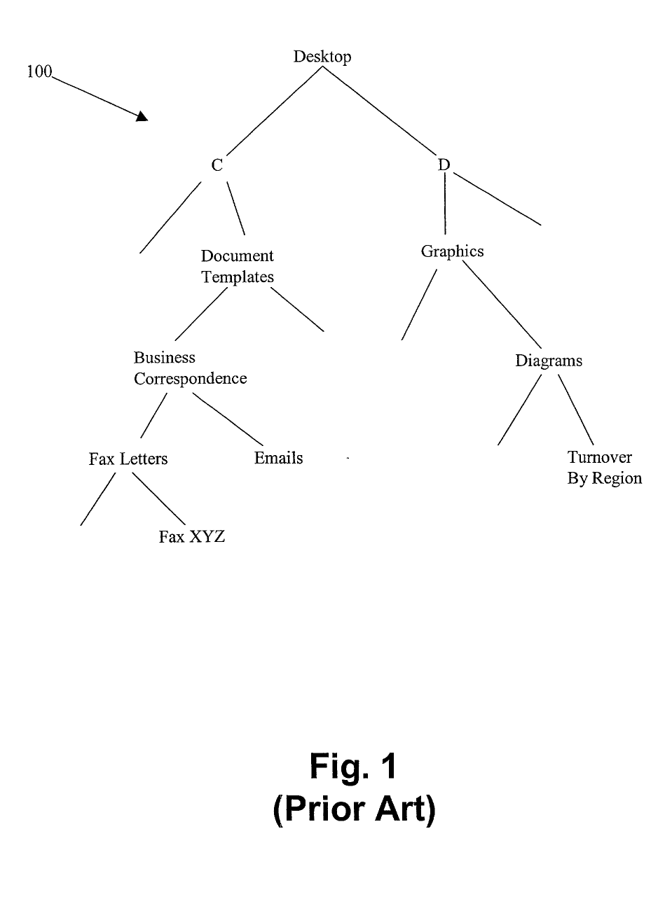

FIG. 2 illustrates an example of a prior art file open window

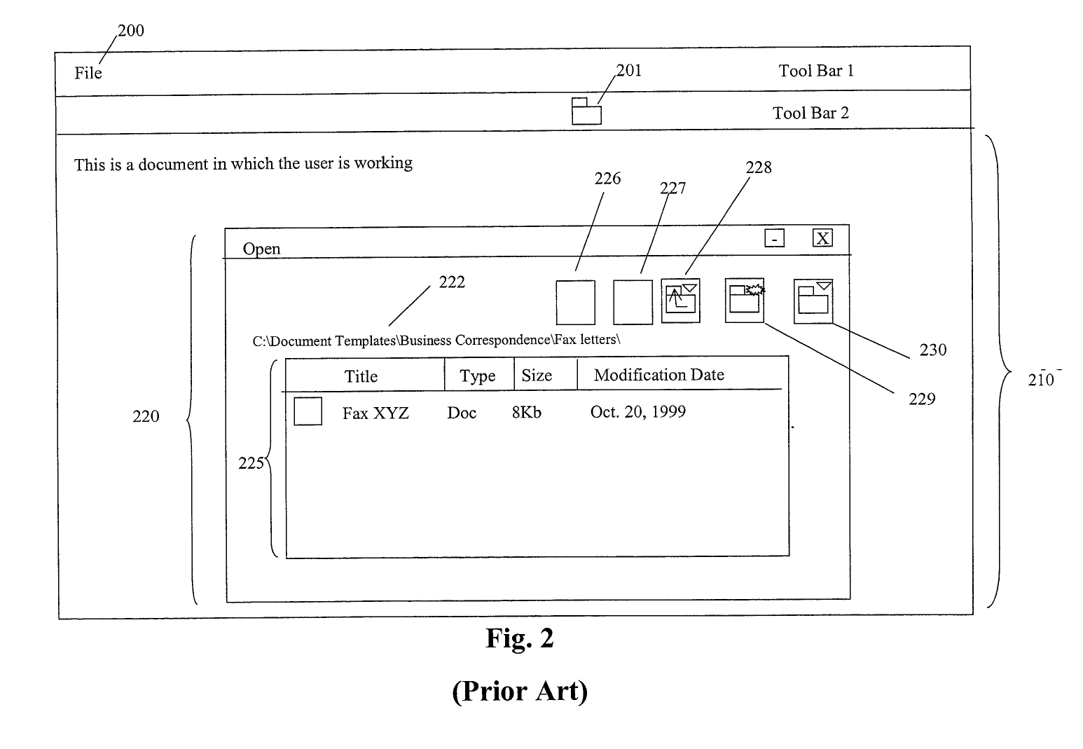

FIG. 3 illustrates a computer system that includes the file open method according to an embodiment of the present invention.

FIG. 4 illustrates a file open window with a file navigation icon according to an embodiment of the present invention.

FIG. 5 illustrates one embodiment of a file navigation dialogue window according to an embodiment of the present invention.

FIG. 6 is a process flow diagram for the file open method according to an embodiment of the present invention.

FIG. 7A illustrates a user selecting an item “Add Folder Bookmark” in the file navigation dialogue window according to an embodiment of the present invention.

FIG. 7B illustrates the window generated in response to the user action of FIG. 7A according to an embodiment of the present invention.

FIG. 8A illustrates a user selecting a directory “Document Templates” in the file navigation dialogue window according to an embodiment of the present invention.

FIG. 8B illustrates the window generated in response to the user action of FIG. 8A according to an embodiment of the present invention.

FIG. 9A illustrates a user selecting a directory “Last Used” in the file navigation dialogue window according to an embodiment of the present invention.

FIG. 9B illustrates the window generated in response to the user action of FIG. 9A according to an embodiment of the present invention.

### DETAILED DESCRIPTION

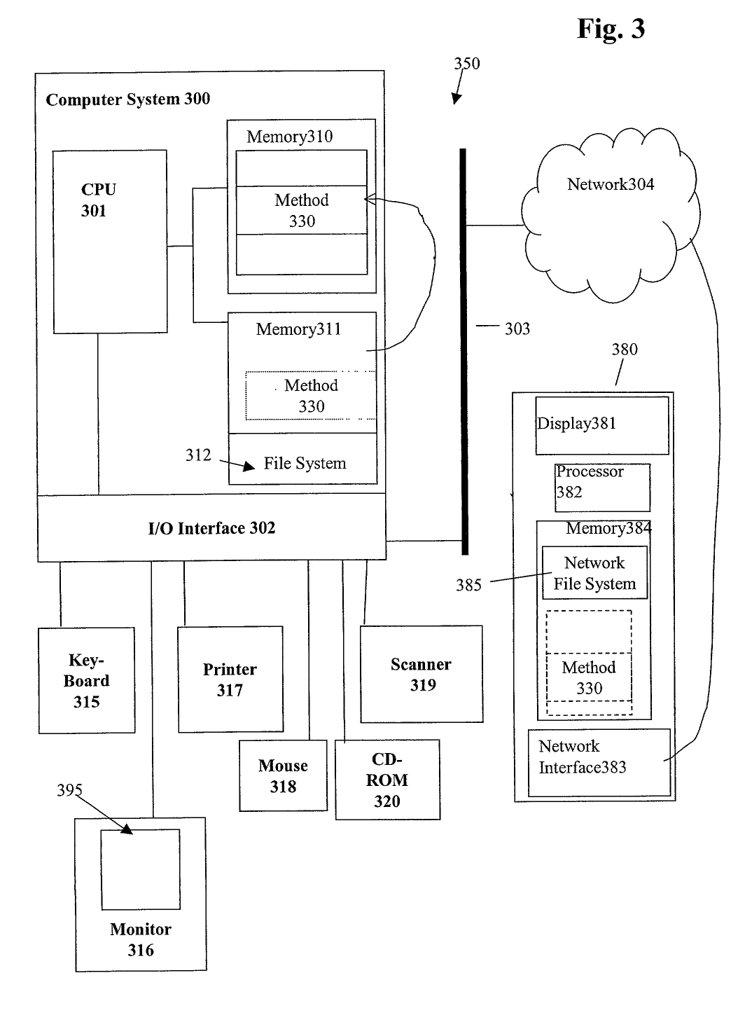

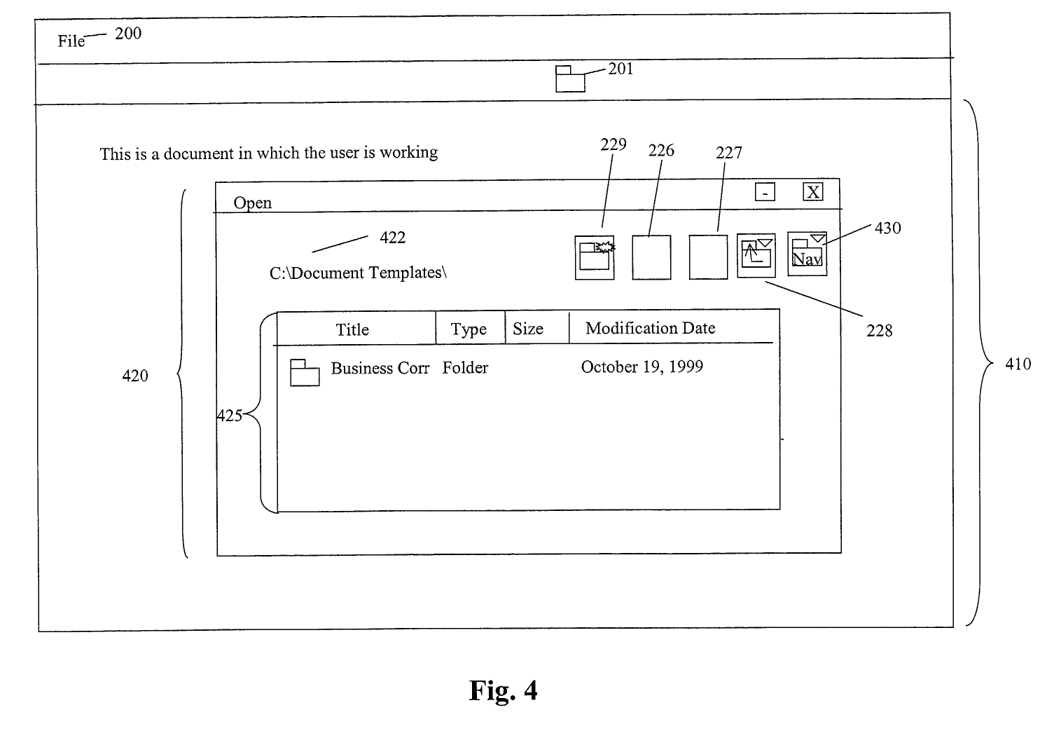

A method 330 (FIG. 3), in an embodiment of the present invention, improves file navigation inside a file system in computing environment 350 and enables the user to easily change from one file directory, sometimes referred to as one directory, to another desired directory. After a user generates file open window 420 (FIG. 4), using for example folder icon 201 and an input device such as mouse 318, e.g., by a first user action, the user is presented with a file navigation icon 430 within file open window 420 on display 395 of monitor 316. The contents of the directory at address 422 are displayed in file content window 425.

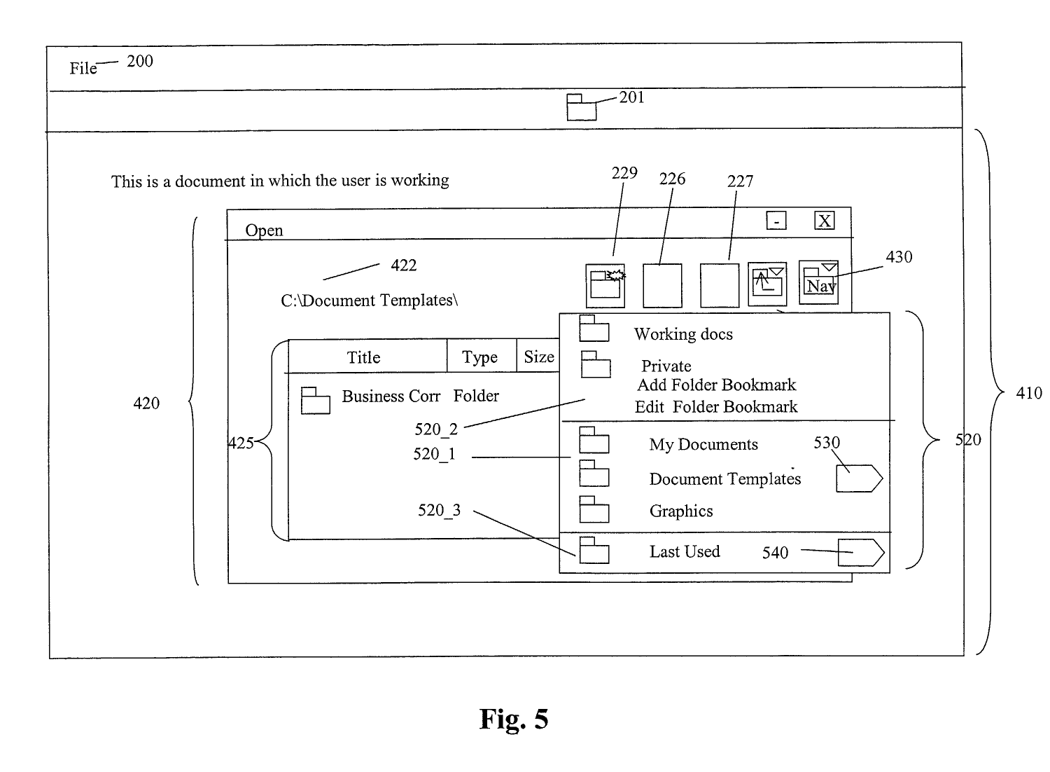

When the user clicks on file navigation icon 430 using mouse 318, e.g., takes a second user action, the user is presented with file navigation dialogue window 520 (FIG. 5) according to an embodiment of the present invention. As explained more completely below, file navigation dialogue window 520 allows the user to easily and quickly find a desired directory in computer system 350. In window 520, the user may select a directory in any one of a plurality of sections 520_1 to 520_3. Each section represents a different category of directories and/or documents. In the embodiment of FIG. 5, the categories include, default, user specified, and last used. Thus, the user may select from defined default directories in a default directory section 520_1, from user specified directories in user directory section 520_2, or from a history list of latest used documents in a last used directory section 520_3.

Hence, to facilitate file system navigation, a graphical user interface of this invention includes file navigation dialogue window 520 that in turn includes a plurality of sections 520_1 to 520_3. Each section in plurality of sections 520_1 to 520_3 includes at least one directory. Those of skill in the art will appreciate that the directory itself is not in window 520. Rather, a representation of the directory, which in this embodiment is a folder icon and the directory name, is presented in window 520. Thus, when it is stated herein that a directory is contained in a window, it should be understood as meaning a representation that identifies the directory is contained in the window. The directories displayed in window 520 may be either directories or sub-directories. Both are generically referred to as directories.

In addition, there is no restriction on the storage location of a directory or a document that is displayed in a section of window 520. This means that the directories do not have to have a predefined hierarchical relationship, and that the directories do not have to be located on the same computer, or even in the same network. The only requirement for displaying a directory or document in any one of plurality of sections 520_1 to 520_3 is that the user is allowed to, and is able to access the directory or document from the computing device being used by the user.

Thus, when a user selects a directory in any one of plurality of sections 520_1 to 520_3, the contents of that directory are displayed in window 425 irrespective of the location of the selected directory in the hierarchical file directory structure relative to the directory contents displayed in window 425 prior to the selection by the user. Again, as used herein, the contents of a directory are representations of the subdirectories or documents contained in the directory.

Unlike the prior art method, there is no required predefined hierarchical relationship between the directory originally displayed in window 425 and the directory selected by the user. The two directories can be on different disk drives, or even in different file systems.

Consequently, a user no longer needs to implicitly know the hierarchical file directory structure and no longer needs to click through that structure to reach a particular document. In addition, with window 520, the user need not know whether the directory is on a local file system 312 of local computer system 300, or is on a network file system 385 of a network computer 380, or is located somewhere accessible via the Internet, for example.

File navigation window 520 preferably is context-independent, that is the style and content of window 520 are displayed on monitor 316 in the same manner irrespective of the document or environment in which the user is currently working. Hence, the style and content of window 520 are independent of the current document context.

In another embodiment, file navigation icon 430 serves a dual function. In this embodiment, if the user simply clicks on icon 430, e.g., depresses and releases the mouse button, the content in window 420 is changed automatically to the user's default directory. Consequently, directory address 422 is the user default directory, and the information displayed in directory contents window 425 is the documents and/or directories in the user's default directory. The user's default directory typically contains document templates, or, for example, typical business correspondence documents.

Conversely, if the user places the cursor on icon 430 and holds the mouse button down, file navigation window 520 is launched. As described more completely below, as the user continues to hold the mouse button depressed and moves the cursor over the various items in the different sections of window 520, each item is highlighted. If the user releases the mouse button while an item is highlighted, the user has selected that item and an appropriate action is taken as described below.

More generally, when the user takes a first action on file navigation icon 430, the contents of a directory are displayed in window 420. When the user takes a second action, different from the first action, on file navigation icon 430, file navigation dialogue window 520 is opened.

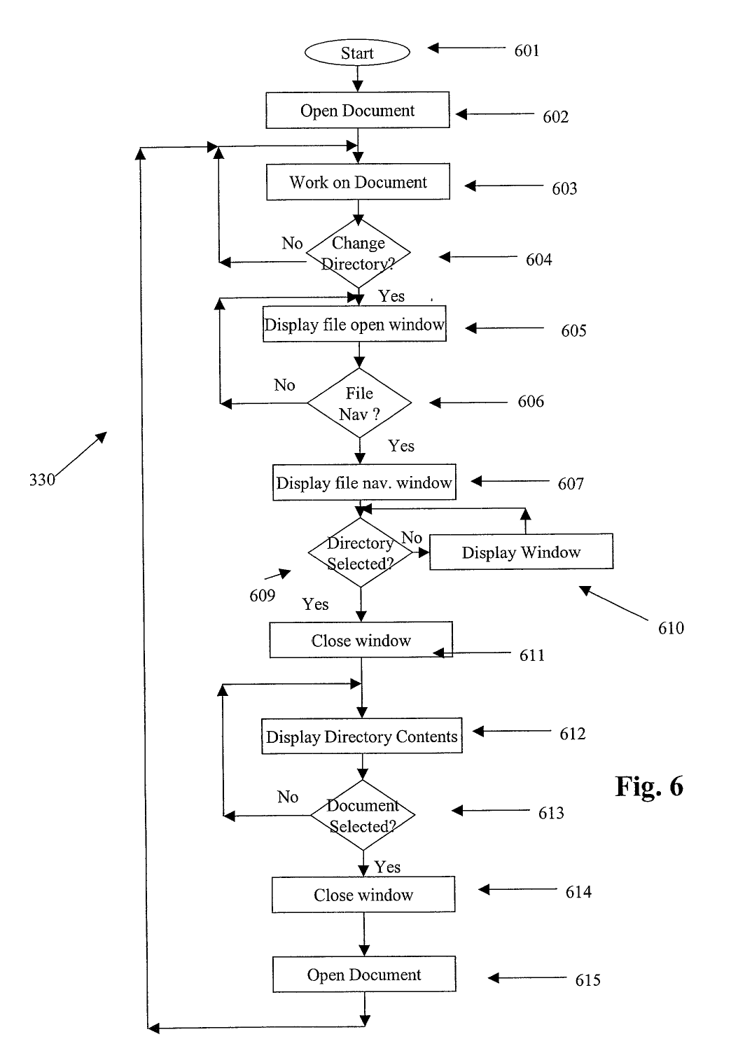

FIG. 6 is a process flow illustrating one embodiment of method 330 of the present invention. Method 330 is illustrated as a sequence of operations. However, as is known to those of skill in the art, an event handler is used with a graphic user interface, such as windows 420 and 520, and when a user clicks or performs an action within the graphic user interface that event is passed to the event handler that in turn takes the appropriate action. Accordingly, the process flow of method 330 is intended only to demonstrate the actions associated with this invention that would be performed by the event handler in response to the indicated input action, and not to limit the invention to the specific sequence of actions illustrated in FIG. 6.

After opening an arbitrary document, for example, a text document, an HTML-document, etc., on computer system 300 in open document operation 602, the user works on the document in work on document operation 603.

Work on document operation 603 transfers to a change directory check operation 604 that in turn returns to operation 603 if the user has not indicated a desire to change directories. Again, this sequence of actions should not be interpreted to require the user application to continually poll to determine whether the user input a request to change directories.

Typically, an application stays in operation 603 until the user initiates an input action other than data entry. This input action is passed to the event handler mentioned above that in turn performs the change directory check operation. Consequently, the return from change directory check operation 604 to work on document operation 603 indicates that processing remains in operation 603 until the action results in activation of the event handler. Similar comments apply to file navigation check operation 606, directory selected check operation 609 and document selected check operation 613 and so will not be repeated below.

If the user wishes to enter another document, for example a graphics document, to edit a diagram, copy the diagram to the clipboard, and then paste the diagram in the current document, the user, for example, clicks on folder icon 201 (FIG. 5) using mouse 318. The use of mouse 318 for input actions is illustrative only and is not intended to limit the invention only to such input actions. Alternatively, the input action could be a keystroke or combination of keystrokes on keyboard 315, or perhaps, a signal generated by voice recognition software or hardware included in computer system 300.

In response to the click on folder icon 201, change directory check operation 604 transfers processing to display file open window operation 605. Display file open window operation 605 generates window 420 (FIG. 4) with file navigation icon 430 of this invention.

The user could take several actions in file open window 420. For example, the user could click on any one of icons 226 to 229, the window collapse icon, or the window close icon. However, only the user actions associated with this invention are described herein.

If the user places the cursor on icon 430 and holds the mouse button depressed, file navigation check operation 606 is activated and transfers processing to display file navigation window operation 607 that in turn generates the display of file navigation window 520.

As described above and shown in FIG. 5, file navigation dialogue window 520 has three sections in this embodiment. A first section 520_1 displays a list of predetermined default directories, a second section 520_2 displays a list of user-defined directories, and a third section 520_3 displays a last used directory.

Section 520_1 preferably contains directories, which either are frequently used by a typical user, or are difficult to find in the hierarchical directory tree or both. In the example of FIG. 5, directories “Document Templates” and “Graphics” are on the user's file system 312, while directory “My Documents” is on network file system 385 and so would be difficult for the typical user to find. Next to directory “Document Templates” in section 520_1 is an expansion indicator 530, which informs the user that directory “Document Templates” includes one or more subdirectories.

Section 520_2 includes directories and documents selected by the user for inclusion in file navigation dialogue window 520. In the example of FIG. 5, the user has added directories “Working documents” and “Private” to window 520. These are directories on network file system 385, in this example, and so are difficult for the user to locate even through these directories are frequently used. The list of user-defined directories in section 520_2 also may contain a shared user directory accessible to a plurality of users, for example, a group of people working on a common project so that the updated documents of the project are easily accessible for all the persons working on the project

In section 520_2 are additional items “Add Folder Bookmark” and “Edit Folder Bookmark,” which are described more completely below. If directory address 422 and the information displayed in directory contents window 425 are for a directory listed in section 520_2, item “Add user directory” changes to “Delete Folder Bookmark.”

Directory “Last Used” in third section 520_3 of file navigation dialogue window 520 is a directory of previously used directories, for example, a number of last used directories of the present computer or network session. Alternatively, however, directory “Last Used” may also contain directories of previous sessions. Also, this directory may contain links to last used documents. Next to directory “Last Used” in section 520_3 is an expansion indicator 540, which, in this example, indicates to the user that directory “Last Used” includes one or more directories.

Upon opening file navigation dialogue window 520, a user has several options that include:

a) selecting one of the displayed directories or documents in window 520;

b) selecting one of the items add or edit folder bookmarks in section 520_2 of window 520; or

c) selecting a displayed directory that includes an expansion indicator in window 520.

When a user initiates one of these selections, processing transfers from operation 607 to directory selected check operation 609. If the user selected a directory by highlighting the directory and then releasing the mouse button, (recall the user placed the cursor on icon 430 and hold the mouse button depressed to launch window 520) check operation 609 transfers to close window operation 611.

Close window operation 611 closes file navigation dialogue window 520, and transfers to display directory contents window operation 612. Display directory contents operation 612 writes the address of the selected directory as directory address 422 and displays the contents of the selected directory in directory contents window 425. Hence, irrespective of the location of the directory selected by the single mouse click in relationship to the directory displayed in window 420, the selected directory is available for use by the user without navigating through the hierarchical file directory structure.

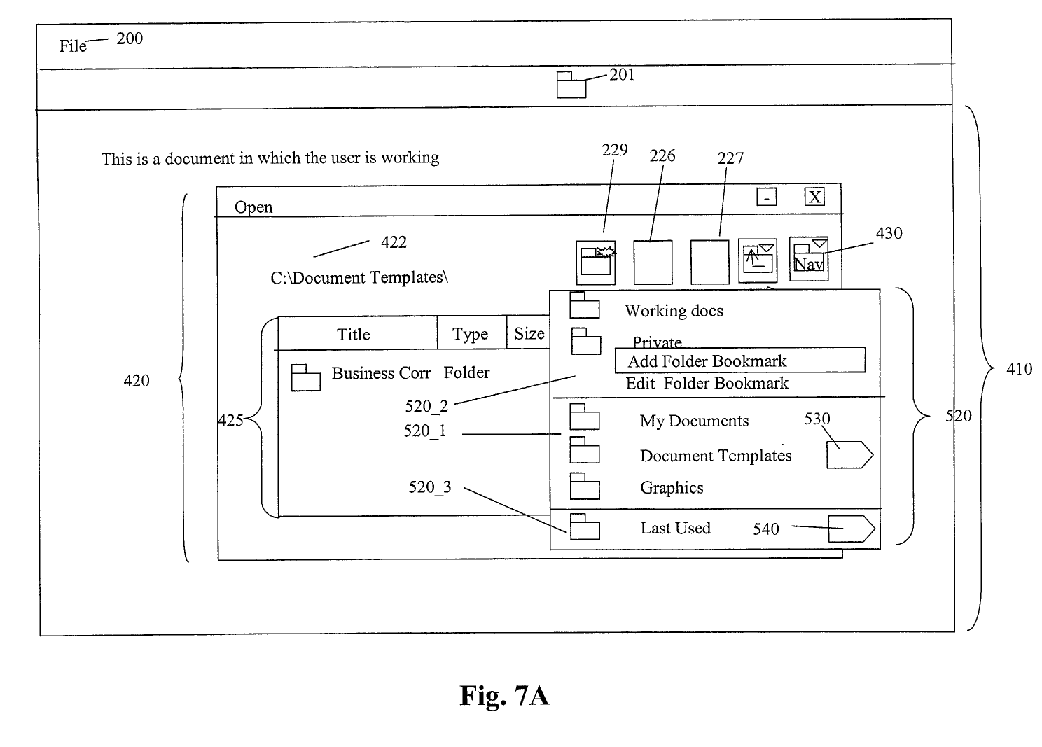

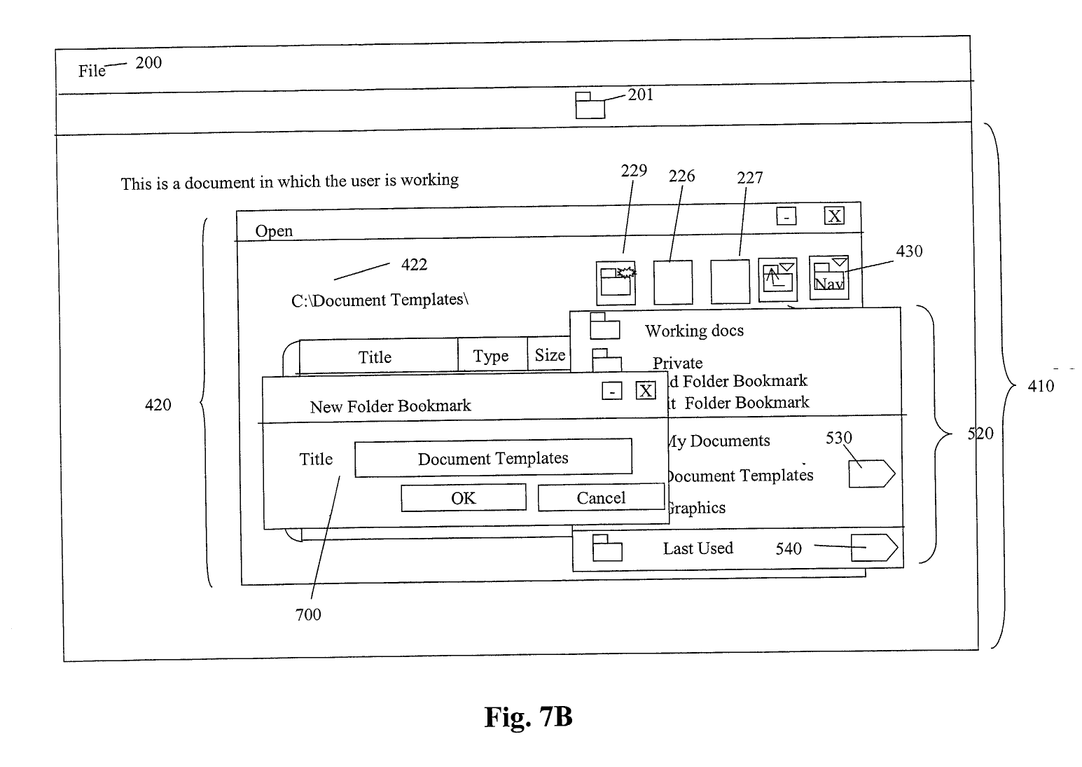

However, if the user did not select a directory, and instead selects “Add Folder Bookmark” (See FIG. 7A) a new dialogue window 700 opens, as is shown in FIG. 7B. In this embodiment, the name of the directory currently displayed in window 420 is entered in window 700 as the title for the bookmark. If the user wants to use a different name for the bookmark in section 520_2, the user types the name in the title box. Upon the user clicking “OK,” a folder icon with the title entered in window 700 is added to section 520_2. The folder icon is linked to the directory displayed in window 420. Window 700 is closed, and display window operation 610 transfers to directory selected check operation 609.

In another embodiment, the user may enter the title of a directory in window 700 and the program searches for the directory with that title and adds the same to the list of user-defined directories in section 520_2.

If the user selected item “Edit folder bookmark,” a window is generated by display window operation 610 that permits the user to edit the title of the bookmark in section 520_2 associated with a particular user directory.

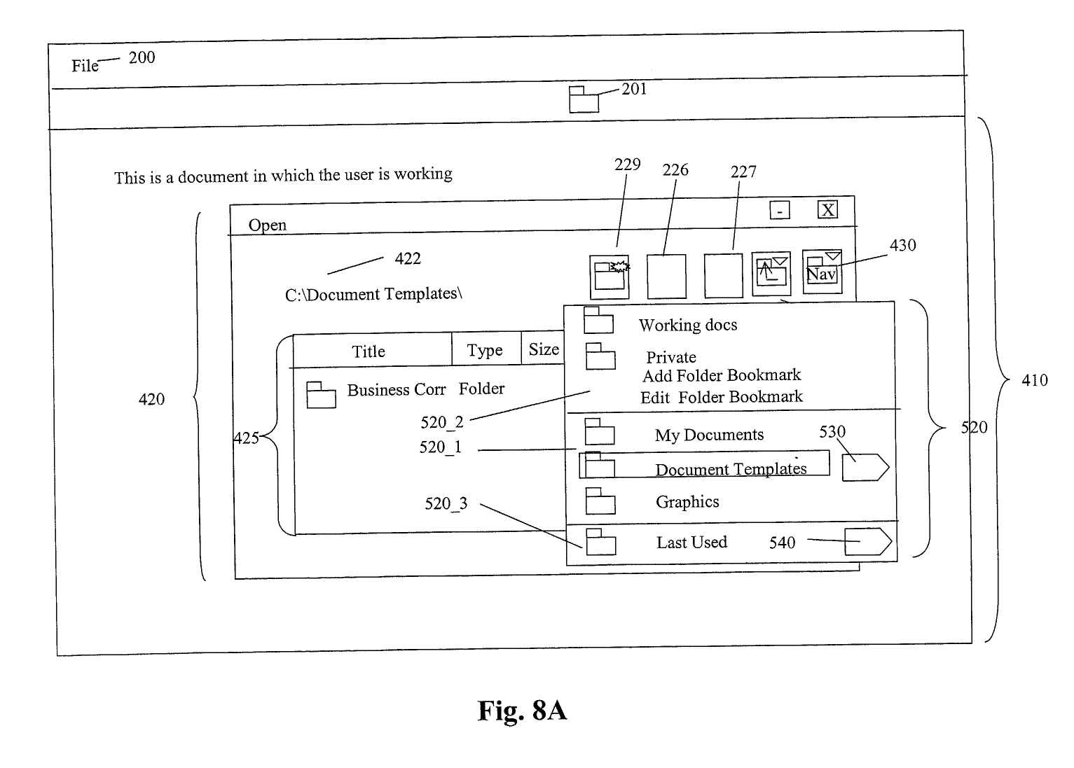

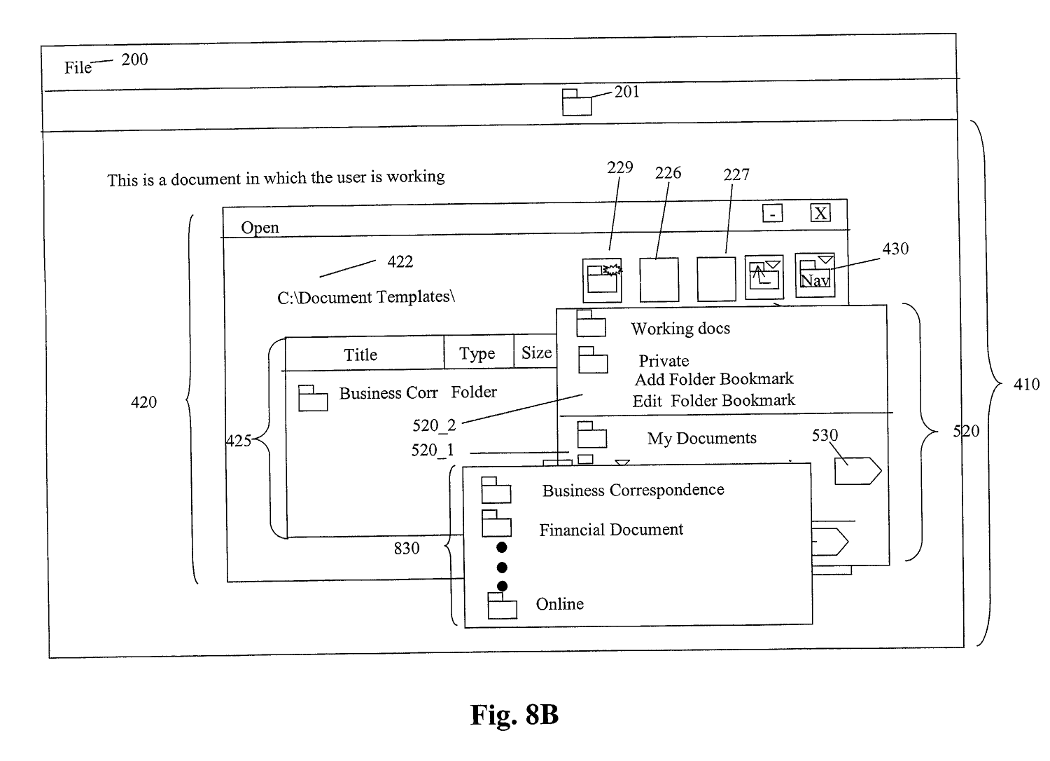

If the user did not select a directory in window 520, and instead selects one of the directories with an expansion indicator, e.g., directory “Document Templates” in section 520_1 (See FIG. 8A), directory selected check operation 609 transfers to display window operation 610. In this situation, display window operation generates sub-directory navigation window 830 (FIG. 8B), which shows the subdirectories in directory “Document Templates.” Display window operation 610 transfers processing to directory selected operation 609.

If the user selects one of the directories in subdirectory window 830 by selecting the directory and releasing the mouse button, directory selected check operation 609 transfers to close window operation 611 that in turns closes windows 830 and 520. Display directory contents operation 612 displays the contents of the selected sub-directory in window 425, as described above.

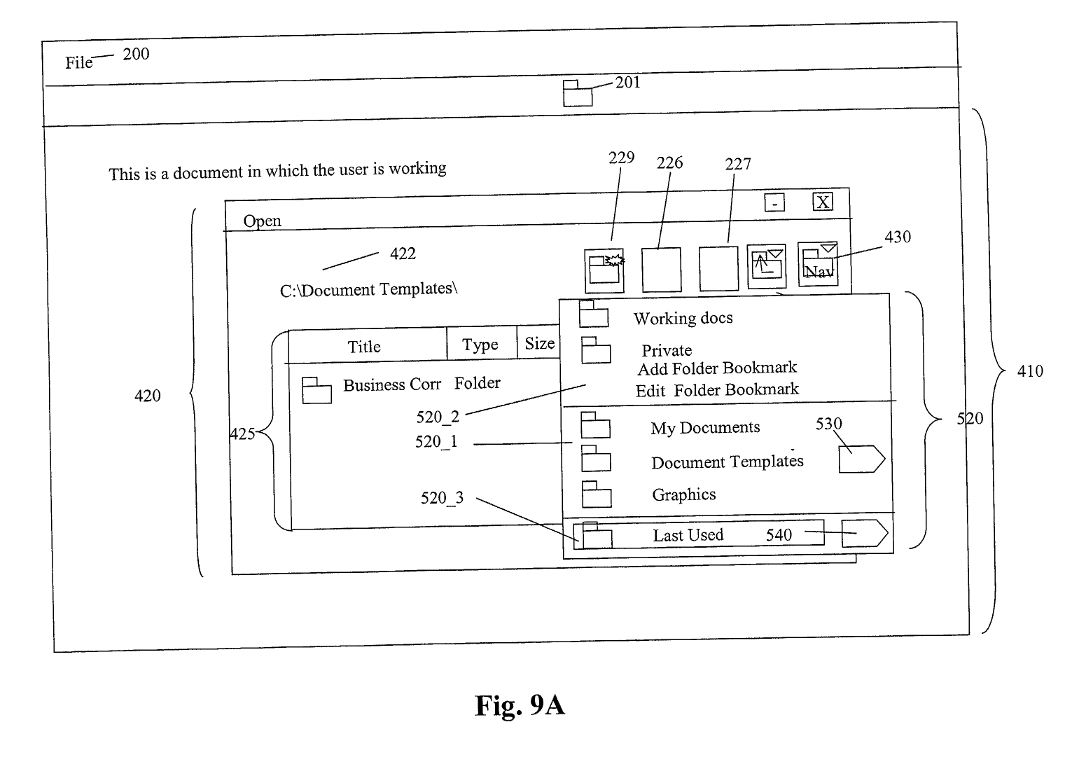

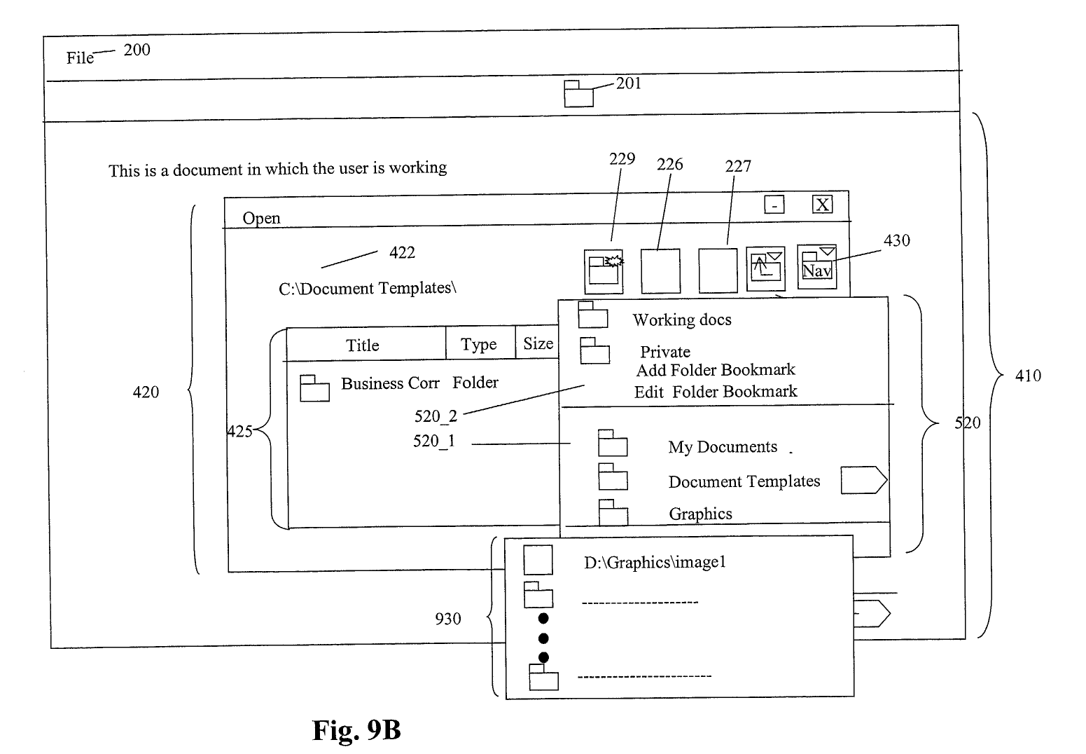

If the user selected directory “Last Used” in section 520_3 (See FIG. 9A), directory selected check operation 609 transfers to display window operation 610. In this situation, display window operation generates last used directory navigation window 930 (See FIG. 9B), which shows the directories in directory “Last Used.” Display window operation 610 transfers processing to directory selected operation 609.

If the user selects one of the directories in last used directory navigation window 930 by highlighting the directory and releasing the mouse button, directory selected check operation 609 transfers to close window operation 611 that in turns closes windows 930 and 520. Display directory contents operation 612 displays the contents of the selected directory in window 425, as described above.

In the above description, it was assumed that only directories were included in file navigation dialogue window 520. However, as illustrated in window 930 (FIG. 9B), documents can also be included. In this case, a document check operation is inserted between the no branch of check 609 and display window operation 610 in FIG. 6. If a document is selected, the document check operation branches to operation 614 and otherwise transfers to display window operation 610.

In the above examples, it was assumed that the user used file navigation dialogue window 520 to select a directory, and that display contents operation 612 displayed the contents of the displayed directory in window 425 (FIG. 4). In window 425, the user can change the order of objects or documents within the displayed directory using the so-called “drag and drop” process within window 425.

The user can select either a subdirectory displayed in window 425 by double clicking on the subdirectory, in which case the contents of the subdirectory are displayed in window 425. If the user double clicks on a document in window 425, i.e., selects a document, document selected operation 613 transfers to close window operation 614 that closes all open windows associated with the file system and transfers to open document operation 615 that opens the selected document. Operation 615 transfers to work on document operation 603 in this embodiment.

With the file navigation dialogue window in an embodiment of this invention, any directory or document in the window is available for user selection “on one click,” independent of the actual location of the directory or document. Hence, the file navigation capabilities are very flexible and can be adapted to the user's present needs. With the default directories in window 520 important document templates and the like are also always only one mouse click away as well as a number of lately opened documents.

Therefore, the file navigation is greatly improved for the user. Furthermore, file navigation window 520 is context independent that is window 520 looks the same and contains the same directories and documents, irrespective of the document on which the user is currently working. The user can so always find a desired document quickly and easily in file navigation window 520, which always looks identical.

One embodiment of the present invention is applicable to a hardware configuration like a personal computer or workstation as illustrated schematically in FIG. 3 by computer system 300. In another embodiment, the invention, however, may also be applied to a client server configuration 350 that also is illustrated in FIG. 3. The file navigation window may be displayed on a display screen of client device 300 while some or all operations of method 330 are carried out on a server computer 380 accessible by the client device 300 over a data network 304 as the Internet using a browser application or the like.

Herein, a computer program product comprises a medium configured to store or transport computer readable code for method 330 or in which computer readable code for method 330 is stored. Some examples of computer program products are CD-ROM discs, ROM cards, floppy discs, magnetic tapes, computer hard drives, servers on a network and signals transmitted over a network representing computer readable program code.

As illustrated in FIG. 3, this storage medium may belong to computer system 300 itself. However, the storage medium also may be removed from computer system 300. For example, method 330 may be stored in memory 384 that is physically located in a location different from processor 301. The only requirement is that processor 301 is coupled to the memory. This could be accomplished in a client-server system 350, e.g. system 300 is the client and system 380 is the server, or alternatively via a connection to another computer via modems and analog lines, or digital interfaces and a digital carrier line.

For example, memory 384 could be in a World Wide Web portal, while display unit 316 and processor 301 are in personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

More specifically, computer system 300, in one embodiment, can be a portable computer, a workstation, a two-way pager, a cellular telephone, a digital wireless telephone, a personal digital assistant, a server computer, an Internet appliance, or any other device that includes the components shown and that can execute method 330, or that at least can provide the display capability and input responses described herein. Similarly, in another embodiment, computer system 300 can be comprised of multiple different computers, wireless devices, cellular telephones, digital telephones, two-way pagers, or personal digital assistants, server computers, or any desired combination of these devices that are interconnected to perform, method 330 as described herein.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

In view of this disclosure, method 330 can be implemented in a wide variety of computer system configurations. In addition, method 330 could be stored as different modules in memories of different devices. For example, method 330 could initially be stored in a server computer 380, and then as necessary, a module of method 330 could be transferred to a client device 300 and executed on client device 300. Consequently, part of method 330 would be executed on the server processor 382, and another part of method 330 would be executed on processor 301 of client device 300. In view of this disclosure, those of skill in the art can implement the invention of a wide-variety of physical hardware configurations using an operating system and computer programming language of interest to the user.

In yet another embodiment, method 330 is stored in memory 384 of system 380. Stored method 330 is transferred, over network 304 to memory 311 in system 300. In this embodiment, network interface 383 and I/O interface 302 would include analog modems, digital modems, or a network interface card. If modems are used, network 304 includes a communications network, and method 330 is downloaded via the communications network.

Method 330 may be implemented in a computer program including comprehensive office application STAROFFICE that is available from Sun Microsystems, Inc. of Palo Alto, Calif. (STAROFFICE is a trademark of Sun Microsystems.) Such a computer program may be stored on any common data carrier like, for example, a floppy disk or a compact disc (CD), as well as on any common computer system's storage facilities like hard disks. Therefore, an embodiment of the present invention also relates to a data carrier for storing a computer program for carrying out the inventive method. Another embodiment of the present invention relates to a method for using a computer system for carrying out the presented inventive method. Yet another embodiment of the present invention relates to a computer system with a storage medium on which a computer program for carrying out the presented inventive method is stored.

We claim:

1. A method of entering a new file directory on a computer comprising:
displaying a file navigation icon;
displaying a file navigation dialogue window in response to a selection of said file navigation icon, wherein said file navigation dialogue window comprises a plurality of sections, and further wherein each section includes a different directory category, and each section includes at least one directory in the category; and
displaying contents of a directory in response to selection of the directory in said file navigation window.

2. The method of claim 1 where said plurality of sections comprises:
a first section comprising a list of predefined default directories;
a second section comprising at least one user selected directory; and
a third section comprising a last used directory.

3. The method of claim 2, wherein the predefined default directories contain a document templates directory.

4. The method of claim 2, wherein style and content of the file navigation dialogue window are independent of the current document context.

5. The method of claim 2, wherein the last used directory contains a latest used directories of the present computer or network session.

6. The method of claim 2, wherein the list of user-defined directories includes a shared user directory accessible to a plurality of users.

7. A method of entering a new file directory on a computer comprising:
displaying a file open window including a file navigation icon wherein contents of a first directory are displayed in said file open window;
displaying a file navigation dialogue window in response to a selection of said file navigation icon, wherein said file navigation dialogue window comprises a plurality of sections, and further wherein each section includes a different directory category, and each section includes at least one directory in the category; and
displaying contents of a second directory, selected in said file navigation window, in said file open window where there is no predefined hierarchical relationship between said first directory and said second directory.

8. The method of claim 7 wherein said plurality of sections comprises:
a first section comprising a list of predefined default directories;
a second section comprising at least one user selected directory; and
a third section comprising a last used directory.

9. The method of claim 8, wherein the predefined default directories contain a document templates directory.

10. The method of claim 8, wherein style and content of the file navigation dialogue window are independent of the current document context.

11. The method of claim 8, wherein the last used directory contains the latest used directories of the present computer or network session.

12. The method of claim 8, wherein the list of user-defined directories includes a shared user directory accessible to a plurality of users.

13. A computer graphic user interface comprising:
a file open window further comprising:
a directory content window; and
a file navigation icon wherein upon a first action on said file navigation icon, contents of a directory are displayed in said directory content window; and upon a second action on said file navigation icon, a file navigation dialogue window is displayed.

14. The computer graphic user interface of claim 13 wherein said file navigation dialogue window further comprises:
a first section comprising a list of predefined default directories;
a second section comprising at least one user selected directory; and
a third section comprising a last used directory.

15. The computer graphic user interface of claim 14, wherein the predefined default directories contain document templates directory.

16. The computer graphic user interface of claim 14, wherein style and content of the file navigation dialogue window are independent of the current document context.

17. The computer graphic user interface of claim 14, wherein the last used directory contains the latest used directories of the present computer or network session.

18. The computer graphic user interface of claim 14, wherein the list of user-defined directories includes a shared user directory accessible to a plurality of users.

19. A computer program product for entering a new file directory having program code adapted for:
displaying a file navigation icon;
displaying a file navigation dialogue window in response to a selection of said file navigation icon, wherein said file navigation dialogue window comprises a plurality of sections, and further wherein each section includes a different directory category, and each section includes at least one directory in the category; and
displaying contents of a directory in response to selection of the directory in said file navigation window.

20. The computer program product of claim 19 wherein said plurality of sections comprises:
a first section comprising a list of predefined default directories;
a second section comprising at least one user selected directory; and
a third section comprising a last used directory.

21. A computer program product for entering a new file directory having program code adapted for:
displaying a file open window including a file navigation icon wherein contents of a first directory are displayed in said file open window;
displaying a file navigation dialogue window in response to a selection of said file navigation icon, wherein said file navigation dialogue window comprises a plurality of sections, and further wherein each section includes a different directory category, and each section includes at least one directory in the category; and
displaying contents of a second directory, selected in said file navigation window, in said file open window where there is no required predefined relationship between a storage location of said contents of said first directory and a storage location of said contents of said second directory.

22. The computer program product of claim 21 wherein said plurality of sections comprises:
a first section comprising a list of predefined default directories;
a second section comprising at least one user selected directory; and
a third section comprising a last used directory.

23. An apparatus comprising:
a processor; and
a memory coupled to said processor, and storing a method of entering a new file directory wherein upon execution of said method on said processor, said method comprises:
displaying a file navigation icon;
displaying a file navigation dialogue window in response to a selection of said file navigation icon, wherein said file navigation dialogue window comprises a plurality of sections, and further wherein each section includes a different directory category, and each section includes at least one directory in the category; and
displaying contents of a directory in response to selection of the directory in said file navigation window.

24. The apparatus of claim 23 wherein said plurality of sections comprises:
a first section comprising a list of predefined default directories;
a second section comprising at least one user selected directory; and
a third section comprising a last used directory.
